(19) United States
(12) Patent Application Publication
(10) Pub. No.: US 2006/0028398 A1
(43) Pub. Date: Feb. 9, 2006

(54) Wireless interactive multi-user display system and method

(76) Inventor: Charles E. Willmore, Boca Raton, FL (US)

Correspondence Address: Oltman, Flynn & Kubler;Suite 415, 915 Middle River Drive, Fort Lauderdale, FL, 33304-3585, US

(21) Appl. No.: 10/897,555

(22) Filed: Jul. 23, 2004

(51) Int. Cl. G09G 5/00

(52) U.S. Cl. 345/2.3

(57) ABSTRACT

A display system includes a wireless sender; a wireless receiver; a central processing unit wireless controller; several microprocessors; several display devices networked wirelessly to the central processing unit wireless controller, each display device being linked to a corresponding microprocessor with a wireless receiver and being linked to the wireless controller; and wireless data input device; where one of a wireless server and wireless microcontroller receives an input signal from a wide area network from a user operating the wireless data input device and distributes signals to the wireless receiver and where the wireless controller signals directly to each of the display devices. A method includes the step of temporarily transferring an image from one display device to another display device for positioning an image at eye level in front of a user.

### BACKGROUND OF THE INVENTION

1. Field of the Invention

The present invention relates generally to the field of computer data transmission and dissemination of content by advertisers and dispensing of electronic content in various formats. More specifically the present invention is an interactive video display system arranged in a multimedia kiosk for the purpose of transmission in the form of advertising on screens-driven by touch screens, video, smart cards, or remotely by handheld IR or RF personal devices (ie. PDA's), providing entertainment, and services, including two way full motion video customer service or chatting by users, public internet access, and multiple associated services (ie. printing of photos or documents, uploading—downloading data, including dispensing audio video (ie. CD's, DVD's), production of photocopies, photos by direct duplication or with the insertion of memory devices ie. (MMC cards, memory sticks, or hooking up an A\V cable to jacks in the kiosk), physical connectivity through cable connectors and wireless infrared (IR) or wireless connectivity (RF) ie. Cell phones, to users locally or remotely. More specifically the present invention relates to an interactive display system with wireless display screens with imbedded microprocessing receivers/transmitters—arranged usually in a multimedia kiosk, or several display screens arranged in any convenient spatial sequence ie. matrix, or clusters each in a column or side by side composed of one input touch screen, jacks for exterior inputs (wired or wireless) or downloads, and one or more output or display screens—in a specific location acting as a kiosk or kiosks within the local area network (LAN) which in turn can be linked either by wires or by wireless transmission to a wide area network (WAN) again through the use of wireless controllers or routers guided by the server of each kiosk, cluster or local area network or from a central server to each server in a kiosk -sending/receiving content ie. voice, data, video, ATM to imbedded micro processing receivers in each display screen or other components of the kiosk ie. ATM machine, scanner, fax, postal scale, printer, or drive, or uploading content from the touch screen in each column to routers in the kiosk server or cluster local network back and forth from the advertisers to users, users to providers of services, administrators of the system to any of the above mentioned categories, or to a passer by who wants to access the system from his personal electronic device ie. wired or wireless MP3 player or wireless PDA, laptop, cell phone, or any other wireless device suitable to talk with the kiosk or cluster in any protocol such as ie. IP, ICP, DIP, IPX, or proprietary encryption. The signal received by the kiosk is evaluated by the server (and it receives wireless or wired content, processes and sends it wireless to the appropriate display screen or device such as audio port or jack if the content is destined for a user wanting to download music ie. for his MP3 player or to a select drive or file to burn a DVD for someone wanting to download a movie: simultaneously the device such as ATM or screen accessed by the user will transmit part of the customers payment to the music studio or film studio owning rights over the DVD or MP3 etc as the case may be and part to the owner of the kiosk.

The display devices preferably will be monitors, CRT's, large video screens, TFT's, liquid crystal displays (LCD's), plasma screens or the screen of a user who has synchronized his pocket RF device or portable TV set, wireless PDA or other device tuned in to one of the frequencies of the imbedded display screen imbedded microprocessor—after paying for the content. The display devices preferably are built into a rack structure forming a video wall, and defining a video kiosk with multiple screens forming a video wall and defining a video kiosk with the terminals extending forward from the forward facing side of the video wall, or clusters of screens arranged conveniently in modules of two or more screens one of which screens will be a touch screen, with its corresponding ATM device, and printer and other corresponding devices such as jacks, ports, scanners, memory slots, etc. or a large screen partitioned in multiple pictures each of which is governed by a separate wireless microprocessing transmitter receiver. The wireless data input means preferably includes touch screens, voice recognition, pen, or pointing devices, or wireless devices RF or IR ie. cell phone or PDA or IR ie cell phone to access wireless at least one or more display screens or devices on the kiosk, or optionally ATM slot, slots or jacks to interface audio or video devices, or memory slots, PDA or any other handheld or physical input device. The inputs are (1) Touch screen (2) voice (3) any smart memory device Ie MMC or smart card (4) any radio frequency device (RF) or infrared device ie. remote control, PDA, Handspring, or cell phone. Content or data can be transmitted wirelessly in any format allowed ie. MP3, MP4, JPEG or other format using protocols such as ie. IP, TCP/IP, 20 IPX, to name only a few. The input devices can also include keyboards or pop-up keyboards on the touch screens, voice recognition, or any of the RF or IR devices above mentioned capable of interfacing with the wireless server, as well as smart cards, credit cards with imbedded micro processing devices, PDA's, cell phones, etc. while the output devices are the screens as human information interfaces, or printer or memory storage devices or audio ie. user of plugs MP3 player to download music, prints, photos ie. camera chip placed in memory slot prints picture for user, games ie. A user plugs in his PDA to a jack or selects a frequency if wireless—to access games 25.

The system is intended primarily for advertising, for interaction with users—including games, and dispensing content in the form of information in hard copy or any memory storage device ie, CD, DVD, memory cards, personal devices IE. Cell phone or PDA, etc. and multiple services through multiple devices such as printer, tickets printer for events, fax printer, postage scale and meter, photo printer—is configured or programmed in such a way that if several users are accessing the same screen and they may rob the advertising space of another advertiser who has content in the screen in front of them) this ad will automatically seek a spot that is empty in the kiosk so the current advertiser for that screen does not loose his advertising money—if there is not a screen available in the kiosk because the users have accessed the same screen and no more spots are available—the kiosk will send the advertisement of the screen being usurped and temporarily transfer its content to another kiosk in a similar location outside the LAN or WAN and then display the content that the user requested on it—once the user finished the ad will come back to its original location.

2. Description of the Prior Art

There have in previous years been various computer and data transmission networks providing consumer information in public places on an interactive basis. None have provided an interactive multiuser display arrangement directed to providing and receiving information relating to the needs of the users in public and non-public places on an array of display devices such as a video kiosk arrangement or clustered arrays—using multiple screens controlled by wireless communication between one input screen and multiple display screen whose content may be accessed wirelessly and then interacted either by touch screen, voice or an outside wireless device such as ie. a smart card or PDA or any other external device allowed by the owner of the kiosk.

U.S. Pat. No. 4,800,376 discloses a multiple display system for displaying data in VIDEOTEX standard. U.S. Pat. No. 4,766,641 teaches an information display system with several electronic display units coupled to a computer device.

It is an object of the present invention to provide a display system including a video wall or clusters holding at least one matrix of video display devices for viewing the screens for entertainment purposes, viewing the separate presentations on separate display devices of the matrix bringing up information on any presentation shown on any one or more of the display devices, or on a personal device linked to the content of any such devices or its server either by physical interfacing or wireless links, the wired devices being coupled to a corresponding microprocessor by jack or physical interface ie. USB, MMC, stick memory, and the wireless devices ie. (RF, IR) communicating with a wireless server wirelessly.

It is a further object of the present invention to provide such a display system including a series of display devices arranged in any spatial order to provide advertisement services, interaction with users, vending of DVD's, CD's, photos, photocopies, prints or any other vending that may be interfaced with the kiosk such as ie. small package dispensing, prepaid credit cards, ID cards, prepaid phone cards, or even dispensing packaged samples from the advertisers than convenient slots when operated by touch screens, voice, or from inputs emanating from personal devices or other handheld IR devices or RF devices, ie. such as PDAS, smart card, cell phone, MP3 player, NAPSTER™, etc. as an input and output.

It is a further object of the present invention to provide such a display to provide wireless linkage between the local server and multiple screens or a remote server as, ie a server in another city ie, a WAN accessing remotely multiple kiosks in other cities or peripheral components i.e. printer, scanner, ATM, etc, components thereof each having a wireless receiver/sender or an imbedded sender/receiver wireless router as each individual configuration may require ie a clustered arrangement of devices controlled mostly by touch screens or from the outside with personal devices, i.e. lap top computer, PDA, cellular telephone or remote access from WAN or LAN to multiple devices having imbedded micro processing wireless senders or receivers, screens, and printers, cameras, ATM reader the other having a postal scale the other member of the cluster having a touch screen and an output screen, a fax scanner, the other having a series of interfaces such as memory slots, audio jacks or mikes to receive or download content, DVD, CD or other type of memory delivery device, etc.

It is still a further object of the present invention to provide such a display system to provide a two way linkage between any of the components that can interface with the kiosk, such as ie. two way audio video, two way linkage to a personal or portable device to obtain data or content from any element of the Kiosk, LAN it composes, or WAN it is part of, ie talk from video phone to screen, send e-mail from any personal device to memory and have it printed for person in kiosk or another kiosk remotely, pay a bill from cell phone.

It is still a further object of the present invention to provide such a display which can be arranged in a structured form as a matrix or combinations or touch screens or display screens with in a free arrangement where the display screens, touch screens, or any device can be combined with other devices such as printers cameras, ATM, Input output interfaces ie. audio memory devices jacks, CD-DVD burners or drives, scanners postal scales, encryption devices, Personal device interfaces such as memory slots, ticket or receipt printers any, none or all which may contain an imbedded sending receiving wireless micro-processor.

It is still a further object of the present invention to provide such a display system which is operated in a wireless manner using a CPU with wireless router receiver/transmitter as controller for wireless reception/transmission of content such as data, voice, video, or other content such as ie. MP3, MP4, JPEG, SPEG or other formats using any compatible protocol such as ie. IP, TCP/IP, IPX, ATM or proprietary by combining any of the touch screens, voice, or devices from inputs/outputs emanating from personal devices or other handheld IR devices or RF devices, ie. such as PDAS, smart card, cell phone, MP3 player, NAPSTER™, etc. as an input/output for commands.

It is still a further object of the present invention to provide such a display system in which the server receives an input from a user using a touch screen or talking to one of the microphones acting as a voice input and combining—if desired, the touch screen input with the voice input to any one of the advertising screens in the kiosk or from a wide area network by input of touch screen or voice in another kiosk, or from the advertisers office, or network administrator—either by wireless or wired link to the LAN (kiosk or cluster)—and the server receives the wireless or wired signal processes it in the kiosk and complies with the request of the user: send it to another kiosk, send it to an e-mail address or to another kiosk in another LAN or WAN, process it in the kiosk, ie. burn a CD, update the advertising screen, or print an airline ticket, or prepaid card, send the content to an e-mail address, send the content to another kiosk, or process the upload/download from a memory card inserted to a slot according to combined voice and touch commands or handheld device commands and if necessary pay for either cash, credit, debit, prepaid card, internet account, or pay via wireless personal device.

It is still a further object of the present invention to provide such a display system which permits interaction between users in the video kiosk (LAN) by sending/receiving content through input/output devices such as display screens (output), touch screens, voice commands, pop-up keyboard in a touch screen, external keyboard, wireless devices (RF) or (IR) ie. PDA, cell phone and physical interfaces plugged into the kiosk ie. USB cable, IEE links, smart card, memory card, memory sticks, etc to a server in the kiosk or cluster which will transmit through a wireless network controller or router in the kiosks or cluster CPU (LAN) to another (lAN) kiosk or cluster wireless CPU router or receiver in another (WAN) or destination by combining any of the touch screens, voice, or devices from inputs/outputs emanating from personal devices or other handheld IR devices or RF devices, ie. such as PDAS, smart card, cell phone, MP3 player, NAPSTER™, etc. as an input/output for commands.

It is still a further object of the present invention to provide such a display system which users are enabled to access multiple components in a video kiosk audio or video recording devices ie. download their music to directly to their MP3 player or CD, DVD burner, or any other device capable of recording or burning an archive or record of voice or video or combinations thereof and to purchase their own movies or infomercials by combining any of the voice, touch screen, or handheld devices as commands, when user pays either cash, credit, debit, prepaid internet account, internet account, or pay via wireless personal device.

It is still a further object of the present invention to provide such a display system which users are enabled to access a postal scale with drop box for overnight, next day, or regular postal service by combining touch screen prompts, or voice commands, creating a label with full destination address, senders information, bar-coded, pre-gummed label dispensed when user pays either cash, credit, debit, prepaid or pay via wireless personal device, and optionally transmit data, i.e., number of transactions to a sponsor/advertiser.

It is still a further object of the present invention to provide such a display system which users are enabled to access printed materials (such as documents from the kiosk itself, advertisers, e-mail addresses (accessible through the kiosk), personal wireless devices such as PDA's to the CPU then print, or physical inputs as or memory chips, photos (from other sites, from their cameras via USB cable or memory devices inserted to reader-slots in kiosk, or wireless sources (such as ie. cell phone), tickets (for any civic, tourist, airline, bus, sports event, etc. through a special ticket printer or the kiosks printer, discount coupons, etc) through a printer when user pays either cash, credit, debit, prepaid, internet account, or pay via wireless personal device.

It is still a further object of the present invention to provide such a display system in which a scanner permits sending/receiving content in the form of copy generated by regular B/W or color printer in the video kiosk or cluster or to transfer scanned images to a format suitable for printing in the kiosk, store in a CD/DVD or transmit to other locations in the wide area network of kiosks other e-mail addresses, CPU's, or ie. personal devices such as text messengers, cell phones, PDA's, etc. when user pays either cash, credit, debit, prepaid, internet account, or pay via wireless personal device.

It is still a further object of the present invention to provide such a display system which users are enabled to access to provide high security access through an iris recognition by a close-up from camera in kiosk and processing image via special software and security analyzers at advertiser, network administrator, or kiosk owner and voice recognition by passing voice of user through security analyzers at advertiser, network administrator, kiosk owner or sponsor locations ie. banks, or sponsors where customers pay their bills.

It is still a further object of the present invention to provide such a display system which users are enabled to access system which provides access to high security ATM devices for payment of bills ie. of sponsors, tickets, services, check cashing, payment of bills ie. water, cell phone, light, credit cards, etc., purchase gift card/prepaid VISA, etc a cash reader is provided with cash dispenser/cash drawer for those unable to provide credit cards can purchase credit card or gift card.

It is still a further object of the present invention to have a biometric device if necessary for high security identification purposes, i.e. a digital print reader or a eye iris identification reader.

It is still a further object of the present invention to provide such a display system which users are enabled to access system which provides access to a drop box for envelopes and parcels which allows users to enter their return address destination address and/or tell the kiosk the return address and destination, calculate the correct parcel depending on if it is an overnight, next day or other type of delivery charge; the printer in the kiosk will produce an envelope and a pre-adhesive label with a barcode for the zip or post code of its destination.

It is still a further object of the present invention to provide such a display system which users are enabled to access system which provides a card printer which enables a user to produce an ID tag, prepaid credit card, drivers license, voters registration card in combination with the voice recognition security screen or the iris image scanned and verified from one of the cameras-allowing ie. to purchase a gift card, prepaid card or even if the issuer allows a credit card.

It is a still further object of the present invention to provide such a display system in which a video camera is provided so users access by touch screens or voice two way audio or video-conferencing and if desired download photos of either of the parties involved, and print them in the kiosk—the two way audio or video-conferencing can also be transacted with any personal device which has voice or video screen such as a cell phone or camera cell phone, and select payment in any of the multiple payment options available, including IR and RF modes of payment.

It is finally an object of the present invention to alternately have a screen with multiple imbedded microprocessors controlling multiple PIP screens inside a single screen each with its own touch icons and capable of delivering displays of information receiving information by such as but not limited to voice, remote touch screen direct touch or any other wireless device, i.e., PDA laptop and cellular telephone.

### SUMMARY OF THE INVENTION

The present invention accomplishes the above-stated objectives, as well as others, as may be determined by a fair reading and interpretation of the entire specification.

A display system is provided, in the kiosk or cluster, including a wireless CPU router/sender controller, a micro-processing receiver/transmitter imbedded in each touch screen (or wired), a micro-processing receiver/transmitter imbedded in each display screen, linked wirelessly to a central wireless controller server router/processor unit, and input devices ie. for commands, data, ATM, or any other processing of content such as voice, touch screen, wireless inputs such as IR or RF ie. cell phone, PDA, or smart cards, MMC's—and several micro-processor wireless receivers/transmitters imbedded as needed in the other components, depending on the spatial arrangement of the kiosk to operate or control other devices that may be desired wirelessly: ie. such as printers, ATM devices, printers—each linked to a wireless CPU wireless server/controller (optionally the printers, ATM devices, microphones, cameras, post scale, ticket dispenser, memory ports or slots, USB devices, smart card readers, signature pads, biometric devices, i.e., iris readers, DVD burner/player or CD burners etc. can also be conveniently linked by cables instead of by an imbedded microprocessor.)

The display devices preferably are arranged in a two dimensional matrix of the display devices defining an interactive multi-user video kiosk, alternatively arranged in clusters by forming clustered modules each with its touch-screen its imbedded wireless microprocessor receiver/sender with at least one or more display advertiser screens with its corresponding imbedded wireless microprocessor receiver/sender as a free standing column or row plus its corresponding memory slots, printers, DVD/CD burner. When arranged in clusters each element of the cluster will have at least one of the display screens arranged above and/or below or both or more above, or both or more below—if arranged vertically and if arranged horizontally, the touch-screen can have the display monitor/s (with their corresponding imbedded microprocessor receiver sender) on either or both sides with at least one of the display screens arranged laterally, or any other combinations thereof controlled by the CPU wireless router controller sender/receiver. In any case of the above mentioned kiosk arrangements: as a wall or cluster or any combination thereof the kiosks server CPU, or clusters server CPU can connect with the wide area network wirelessly through imbedded microprocessors, by a wireless sender/receiver router, or wired in any convenient manner and will then in turn link with the corresponding display screens wirelessly through the imbedded microprocessors. The signals optionally can be sent in any software program in protocols such as any one of ie. IP, ICP, OIP, IPX, or any other including proprietary protocols. The signals received from the wide area network, or from any inputs locally at the kiosk: ie. the touch screen, PDA, voice input, or any other means of input is analyzed by the wireless CPU server at the kiosk (LAN level—this signal may be originated internally by any input means on the kiosk or cluster, or by external means proceeding either from the WAN, or any other source ie. from an individual CPU at the administrators headquarters, at a CPU located in one of advertisers office or from any authorized user from his device ie. laptop, PDA, Cell Phone, smart card, memory device, camera, smart chip, or IR device, cable link to the kiosk such as USB devices or even by inserting an external smart card, drive—will prompt the server CPU router controller to analyze and decide the destination of the signal and where it is routed, etc. The display devices preferably are one of ie.: monitors, CRT's, TFT's, liquid crystal displays, Plasma screens or a screen brought by an user linked by other wireless protocols such as ie. a cell phone or PDA, wireless cards or drives, MP3 or other players or wireless burning device or capturing devices. The display devices preferably are built into a supporting rack structure forming a video wall forward facing side with the display devices extending forwardly from the video wall forward facing side in a single kiosk or any other spatial arrangement if in clusters.

The input devices preferably includes one or more combinations of: touch screens, voice (through voice recognition), IR infrared ie. pen, signature pad, mouse, etc, or any other wireless memory device or external wireless device RF ie. cell phone or PDA or any device linked by cables or ports, jacks, memory slots or USB, or any physical link ie. parallel ports, serial ports, PDA interface cables, smart cards, MMC cards, memory sticks, etc. when linking a PDA to the kiosk the user can elect using his PDA as an input output device linked to the kiosk.

A method of displaying information with a display module for the public including a CPU wireless sender controller/router in the kiosk or cluster linked wirelessly or wired to outside sources such as WAN, or advertiser, or administrator or any other mode to the internet, wireless touch screens with an imbedded microprocessor receiver/sender mainly as input or if desired output, several display (advertising) screens networked wirelessly through imbedded micro-processors each with their sender/receiver acting mainly as output, several display devices networked wirelessly through imbedded transmitter-sender micro-processors, linked to the CPU router wireless transmitter/receiver controller server and various input output devices wired or with also operating with imbedded microprocessors as needed, for linkage with the CPU server which receives a signal from a local user through any touch screen or from a wide area network, or from a user at another kiosk in another city, or from a user with any handheld device ie. PDA, cell phone remotely or locally, where the CPU receives or sends according to need—signals from users at touch screens to any display screen (or their ultimate advertisers by dynamic links, keywords, hyperlinks, or any other links) through any protocol ie., IP, proprietary, etc. or any user with a personal screen or audio or memory device ie. IR or RF: PDA's memory cards, cell phones, MP3 player, NAPSTER™, etc. and the display screens are arranged in a two dimensional matrix of the video devices forming a video kiosk or cluster of kiosks with each element containing at least one or more touch screens as input or output, or microphone for input for voice recognition, or camera, or IR or RF, joystick, or keyboard, or remote IR or RF personal device Ie. PDA, smart card, cell phone: the method including the step of talking to the kiosk, or by selecting, pointing, and touching on a touch screen a given icon from the plethora of icons shown on a touch screen mapping the other display screens in the kiosk or WAN—or selecting on his own device Ie. cell phone, PDA selecting an icon in his screen of the cell phone or PDA that also is part of the icons in the kiosk will first transfer the content of the screen he selected to the screen closest to his eye level—and if in effect the user is searching the advertisers in the kiosk, or if desired he can select from a map of all the icons in the WAN or alternatively if he is searching outside the kiosk-instead of icons he will see the content in a traditional internet format, the same internet format will appear, if he is not searching for content in the LAN or WAN's connected with our system. If multiple users have accessed the same display screen, and the advertiser they have accessed needs to be displayed, taking over an existing advertiser displaying content on the screen closest to the user or because all the screens in the kiosk are taken and the advertiser on the screen in front of the user has to give in to the one the user selected: the advertisement screen previously in front of the user will swap its position with the screen position of the advertiser he selected—but if two users select the same ad—then it may be the case that the common advertiser they have selected can not accommodate the two separate advertisers now displaced at each one of the user stations—so the system will try to find a screen in the kiosk or cluster first that will accommodate one of those advertisers temporarily displaced, or will transfer the second screen being used to another position in another kiosk belonging to the WAN, this will insure that advertisers will not loose the money paid for their advertising screen—this procedure should insure that each user has the content he searched in front of him.

The method preferably includes the additional steps of: as the icon is selected for the display screen and once the advertiser of the screen selected is in front of the user—the icon representing his choice will vanish and display a menu—which may have buttons or icons from which he can continue making selections or instructions to proceed, the same format would transfer to the screen of a user accessing the information from a laptop, or PDA, or cell phone with any modifications necessary to conform to the software in the PDA, or the size of the PDA screen, or any other protocols for the device they are accessing through to work. As the users navigate through the menus: the formats will change and new icons or selections will appear and as reason may dictate that the system will display icons or keywords or hyperlinks for the user to proceed. The imbedded micro processing wireless devices permit any screen to be an input and output or touch screen although preferably there may be icons mapping the whole matrix with each of its advertisers, or the LAN, or each cluster, or even a map of WANS that the user can select any of its icons just by touching it, enunciating a key word, or selecting the advertiser from his remote device, such as but not limited to a PDA, lap top computer and a cellular telephone.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a front view of a video kiosk arrangement of display devices in the form of terminals each having a touch screen that can be used as an input output or output device and linked to the server-CPU-wireless router transmitter-receiver via an imbedded microprocessor in each of the screens with a wireless transmitter/receiver. All display units and touch-screens have imbedded wireless microprocessors capable of linking to the CPU and as a stack of display units plus ancillary elements which can also be operated by imbedded wireless microprocessors or optionally a printer or other device can be wired and collectively can form the kiosk, cluster or PIP. screen. The terminals are accessed and used by the public by touch screens, voice commands, keyboard, or from external access methods also wireless including but not limited to IR or RF ie. PDA's, cell phone, smart cards, memory devices and physical interfaces inserted in memory reader slots or ports, USB linkage for devices to be operated such a cameras, or lap tops, smart credit cards, cards with their own chips, or external memory devices ie. such as a drive with a preprogrammed set of instructions that alternatively can interact with any of the above described input-output devices, The system may include a printer or printers wired to the CPU or each device with its own imbedded microprocessing transmitter receiver for ie. receipts, data, drawings, photos, tickets; DVD-CD burner or any other burner or device to download content ie. MP3 or MP4 devices to access or load music or video or burn a blank smart card: external ports or jacks, ie. to listen to audio, or to link a USB driven device, or to burn internally or externally a DVD or CD, or hook up and re-edit in different format a CD/or DVD (MP3 to MP4 or one digital format to another format) or to provide access for outside printing device to print reports or other content from the kiosk. Signals can be sent in any protocol ie. TC IP, IPX, encrypted, or any other.

FIG. 2 is a diagrammatic block diagram of the invention showing the major elements, which is in the form of kiosk and one of the many spatial arrangements possible with imbedded microprocessors with wireless transmitter receivers in the screens. FIG. 2a is a diagram as in FIG. 2 except that transmitter receivers are hard wired.

FIG. 3 is another diagrammatic block diagram of the invention showing some of the major building blocks, which would form a kiosk and one of the many spatial arrangements possible by the use of imbedded microprocessors with wireless transmitters receivers in the screens.

FIG. 4 is an elevational side view of the enclosure of the kiosk holding major elements, which is in the form of kiosk and one of the spatial arrangements possible by the use of imbedded microprocessors with wireless transmitters receivers in the screens.

FIGS. 5a and 5b are respective elevational front and side views of one interactive touch screen mapping the other display or interactive screens in the kiosk or cluster.

FIG. 6 is a representation on the touch-screen with icons mapping the advertising or other interactive touch-screens contained in the kiosk which at users option can bring up at will a touch-keyboard to type in information (as opposed to a regular external keyboard).

FIG. 7 is a diagrammatic elevational front view of an arrangement of the kiosk as a video wall containing interactive touch screens and other display or interactive screens, and a group of rack mounted work stations serving the with imbedded microprocessors with wireless transmitters receivers in the display screens and with imbedded microprocessors with wireless transmitters receivers in the touch-screens.

FIG. 7a is a variation of the arrangement shown in FIG. 7.

FIG. 8 is another elevational front view of a region showing interactive display screens and interactive display screens a set of various system components, a rack mount for work stations, and a hub as one of the many spatial arrangements possible by the use of imbedded wireless transmitters receivers.

FIG. 9 is a typical computer layout for the display arrangement according to the invention.

FIG. 10 is a schematic of the system showing generalized element relationships. The LAN may have a wired or wireless connection to the CPU wireless transmitter, and all other elements are connected to the CPU wireless transmitter wirelessly only. Each kiosk cluster or collection of display I/O devices may act as a “hot spot”, in the form of a relay station or wireless transmitter.

FIG. 11 illustrates a single screen partitioned into regions which are each controlled by an imbedded microprocessor, so that one screen can simultaneously carry multiple separate advertisements.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

### First Preferred Embodiment

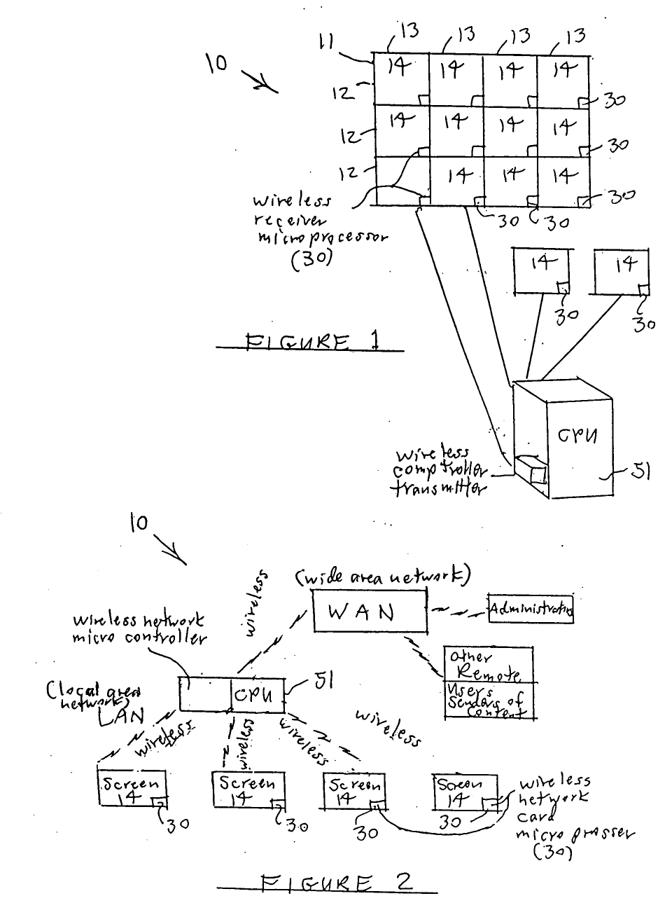

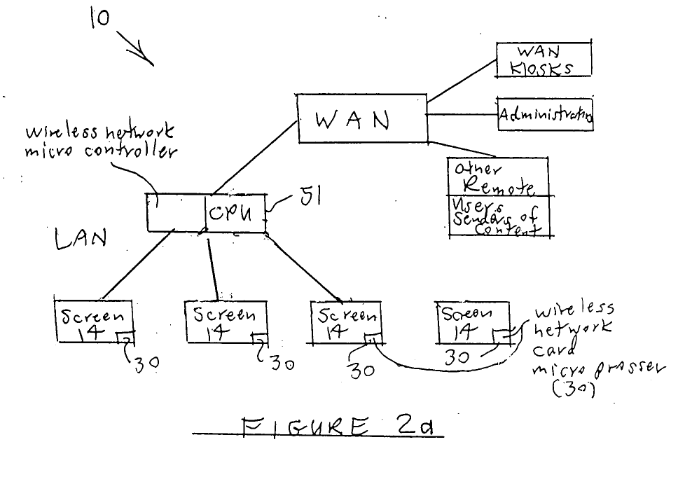

Referring to FIGS. 1-11, a display system 10 is disclosed including a wireless sender and a wireless receiver. The system includes a number of display screens 14 preferably arranged in any spatial order but preferably in a cluster or video kiosk 20 defined by a two dimensional matrix of display devices in the form of display screens, each screen with their own built in imbedded microprocessor with a built in a wireless transmitter receiver 14 networked wirelessly to a central processing unit (CPU) 51 controlling wireless router transmitter/receiver. See FIGS. 1 and 2. At least one and preferably several separate data input means are provided for operation of the system by one or more individual users, each data input defining an individual workstation. The kiosks server CPU router or wireless receiver may receive a wired or wireless signal from a WAN, from a user in another kiosk, from an administrator of the system, from a wireless user (IR or RF device ie. PDA, cell phone) in front of one of the display screens, an advertiser wanting to update content from their headquarters, or a user at home wanting to access the kiosk and view content from one of its screens wants to initiate a transaction and sends either a wired or wireless signal to the kiosks CPU which in turn will analyze the message sort it out and process all the handshaking protocols as well as the security protocols, routing, and link the user whoever this may be with the appropriate connection—if the connection is intended to be one of the display screens including any of the touch screens the signal will be relayed from the CPU's router no matter how it was received either wired or wireless as a wireless signal to the display screens and/or to any other wireless device that the kiosk may have. Each display screen either touch or merely display has its own imbedded microprocessor 30 and its own built in transmitter receiver and its own address in the internet and in the system-rather than its own CPU or being wired to the kiosks server. Once the kiosks CPU 51 router receiver controller receives a signal either wirelessly or wired mostly from an outside source ie. such as an advertiser updating his screen, or from another WAN with more kiosks—it will decide if the signal has to be sent to any of the displays in which case it will be wireless 14. Signals are sent on any protocols ie. IP, ICP, DIP, IPX, proprietary or encrypted. If the signal is intended for a printer or other device in the kiosk, other than the display screens or touch screens—it may be hard wired, or wireless, the same applies to other devices such as postal scale, ATM, or any users or advertisers personal device such as ie. IR or RF ie. PDA, or cell phone, or a wired jack for a user to plug in his MP3 player or link a USB cable to print his photo, or insert a memory device into a slot to print a photo, of course unless the device receives or sends data exclusively in a wireless or wired mode as the case may apply. The signal received from any of the input means is evaluated by the server CPU router controller which decides where and how a given signal should be sent, transmitted, stored or, routed; such as inside video kiosk 20 to the user making a request ie., to burn a compact disk (CD), or to another video kiosk 20 in the WAN, or to another computer outside the wide area network, or to an element of a clustered arrangement composed of independent columns conveniently spaced not in the matrix arrangement herein referenced, or wirelessly to a person outside the display screens using his own input-output device such as ie. cell phone, or PDA, or laptop.

The display screens 14 preferably are monitors CRT's, TFT's, liquid crystal displays (LCD's), plasma screens or any other screen as well as personal devices such as IR or RF controlled ie. cell phones, lap tops, PDA's, MP3 players, etc. The display screens 14 preferably are built into a supporting rack structure forming a video wall 18 and defining a video kiosk, such as seen in FIG. 4, in a side view elevation, with the terminals 17 extending forwardly from the forward facing side 19 of the video wall 18. The data input means preferably include touch-screen or voice input means, and optionally includes pen, signature devices, mouse, keyboard, or any IR or RF device ie. PDA's, cell phones, lap tops; or any physical link such as ie. smart cards, USB links, memory sticks external drives, MP3 players, etc.

The wireless or wired data input means preferably includes touch-screen or voice inputs, keyboards, touch screen keyboards, or original document to be faxed or sent ie. as e-mail attachment, photos to be sent to the CD, burner or as attachments in an e-mail, as well as any other wireless RF device ie. wireless PDA ie, handspring, cell phone, mouse, laptop, etc. just to name a few; or infrared transmitting device (IR) ie. pen device, mouse, remote microphone, etc.; or any other hand held wireless or wired device ie. an MP3 player hooked into an audio jack to upload music, a DVD player to upload video, smart memory devices to upload:ID information, credit information, transfer funds or communicate and provide security clearance ID, etc; or wired devices using memory slots such as ie: MMC, memory sticks, devices with a USB linkage or any other linkage such as serial connectors, or any external drive or memory device that can be manipulated in combination with any of the other wireless or wired inputs. The data or other inputs or content including touch screen wired or wireless can be in any format or protocol that the user may access from the kiosk such as uploads of MP3 ie. a music composer wants to upload his songs to one of our screens to market his music—he plugs a CD player with his songs and accesses the proper menu to upload this type of content, the same for a home movie maker, or literary author—they can upload content to any given destination in the kiosk, WAN, or internet for a fee. Users can transact in any format as ie. IP, TCP, IP, IPX, to name a few or proprietary.

The system is primarily at first instance an advertising center through the video display 14 and touch screens, which permits the viewers to access and transact instantly through the interactivity provided by the kiosk touch screens and display screens which in the wireless kiosk or clusters can be placed at will; when the advertising screen is accessed by more than one user the corresponding touch screen they are using which also has advertising content is displaced first to the position of another touch screen which is vacant or to a vacant display screen inside the kiosk, or to another screen in the cluster—if no screen is found it will transfer from the existing kiosk or cluster 20 to another kiosk in another location 20. The outputs can be images on the screens (ie. hyperlinks, menu, icons, commands, or buttons, keywords displayed for the user to enunciate as commands), printed material (ie. Photocopies, photos, voice instructions), CD's or DVD's dispensed from a DVD-CD burner, tickets for sports or civic events, cash from the ATM devices, a smart card printed from the smart card burner, a label from the postage dispenser, a fax or e-mail from the printer.

Where the data input means is a touch screen or voice the menu will display at first a map of icons or commands with icons and keywords the user can touch or enunciate, or point with a pen or RF, IR device once he selects the icon the screen will vanish and the content of the advertiser he selected will offer new screens that will open with new possibilities, selections or commands the user can select.

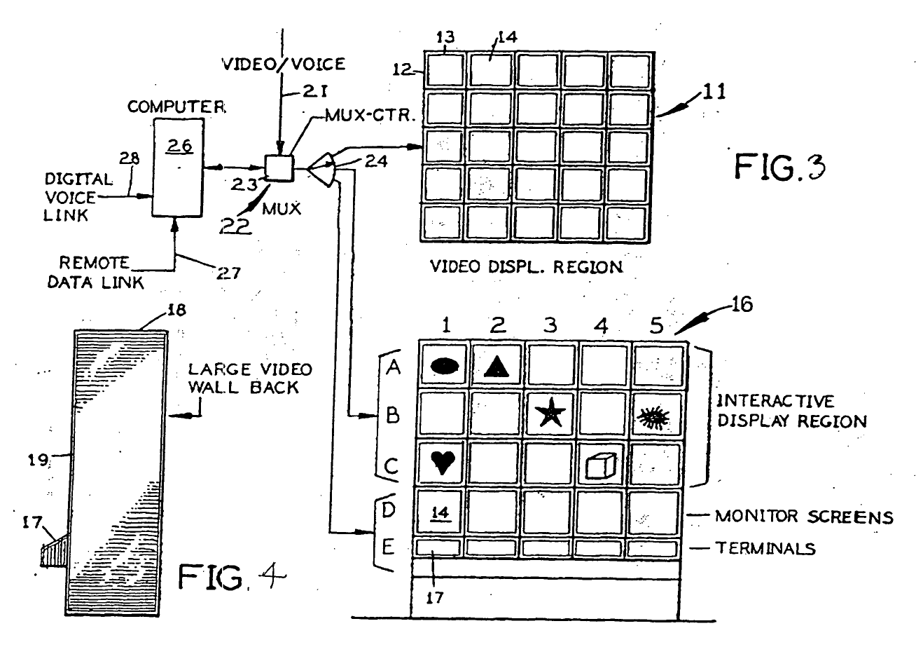

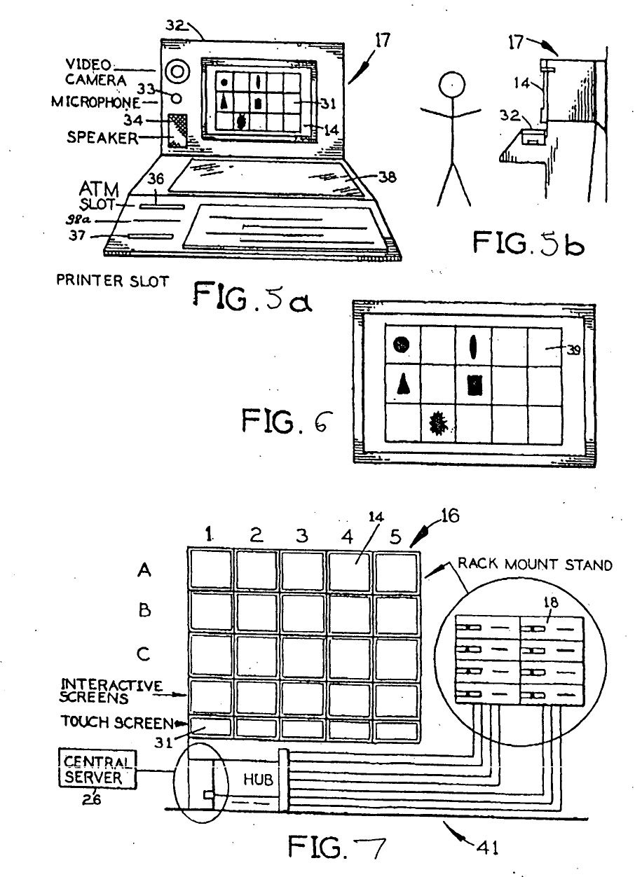

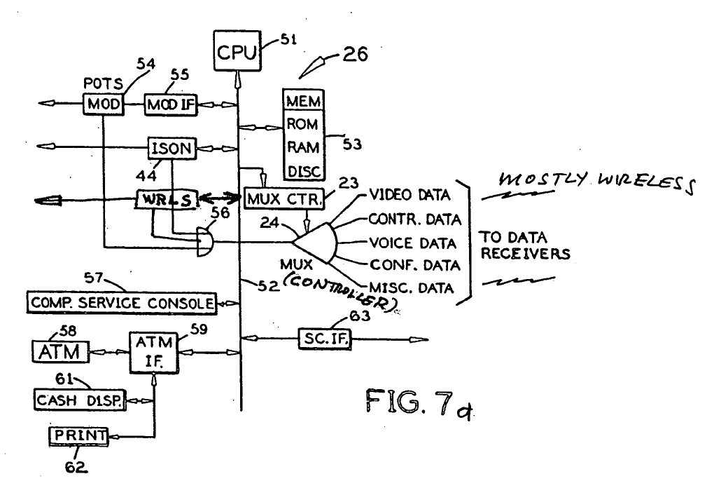

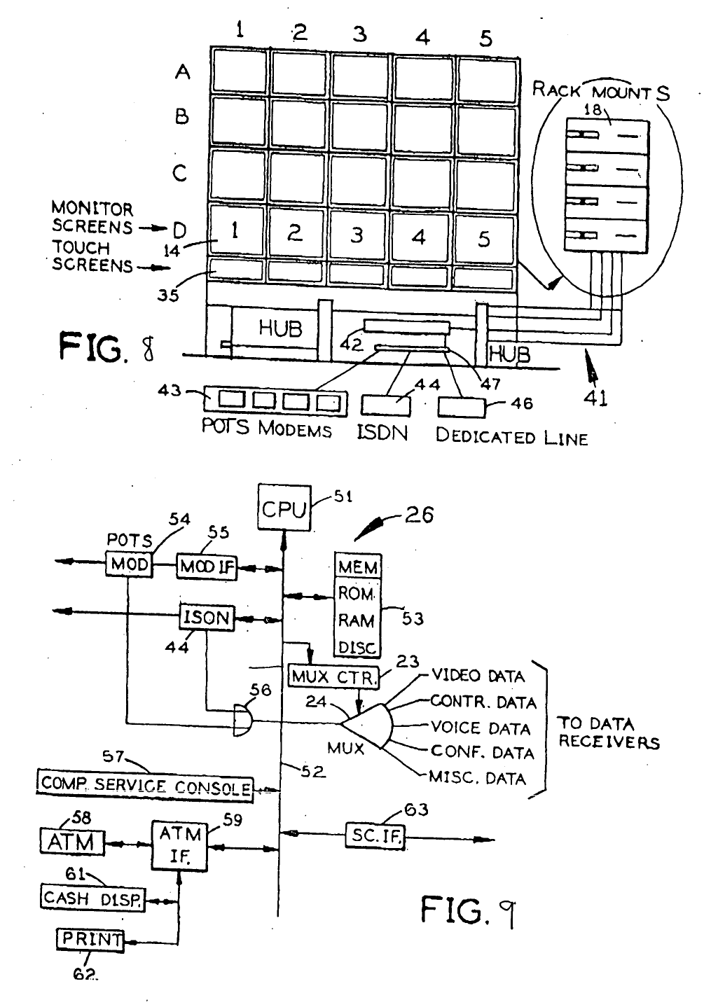

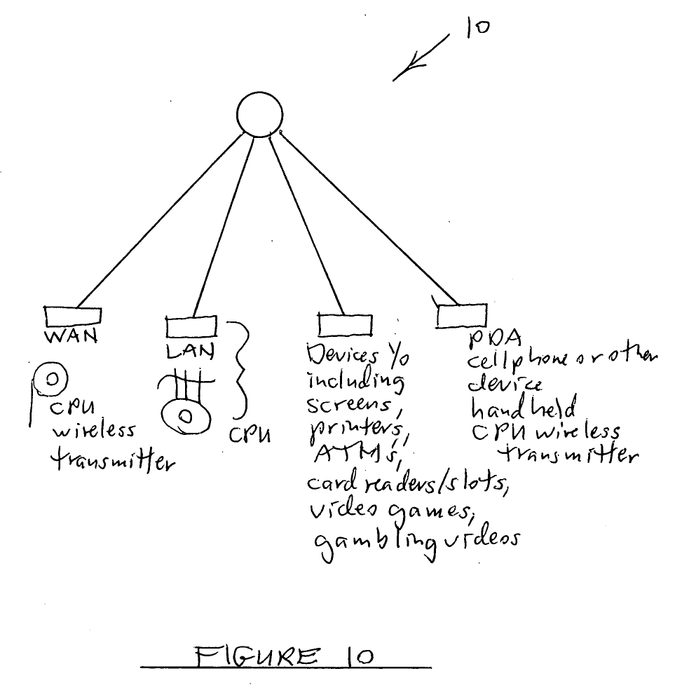

The system is substantially similar structurally set forth in the disclosures of U.S. Pat. No. 6,680,714 issued on Jan. 20, 2004 to the present applicant—some of which is repeated below and all of which is incorporated herein by reference—with many of the same elements expanded by the wireless imbedded micro processing transmitters and without the limitations of a wired system which was confining and did not allow the freedom of placing the touch screens or display screens at will—the imbedded wireless transmitters/receivers micro processing monitors allow such freedom without violating previous art—by eliminating the display area band interactive area—the concept of clustering would not be chained by the limitation of a display area and an interactive region). In FIG. 3 a substantially planar video display 11 is formed as a matrix of horizontal rows 12 and vertical columns 13 of display screens 14, each display screen 14 preferably being a cathode ray tube, LCD, TFT or any other display device which can be used as a screen in the intended wireless application. Two video display walls preferably are positioned with their back sides facing each other and spaced apart sufficiently for a maintenance person to work between them. Alternatively the two walls are positioned at intersecting planes. The entire structure preferably is formed as a video kiosk 20 constructed to serve the public with information, entertainment or a plethora of services connected with the use of today's information and telecommunications technology as described above. If no room is available the system can be arranged in two display units or placed on a track and slid open for service or conveniently arranged in clusters since the wiring has been eliminated and the imbedded wireless micro processing devices in the screens now can link with the touch screens at a central server with all the printers, ATM, card readers, wired interfaces or the clusters can be arranged in a more decentralized manner rationally allocating the printers, ATM devices for payment, printers, scanners, etc. according to the location that the cluster is destined to be placed. This could be like in diagram (XX) where the server is located at the center and there are several display screens or wireless imbedded touch screens with or without a corresponding display advertising screen attached to it. A video voice channel enters the system 21 enters the system at the input of the (multiplexer should read) router controller arrangement 22, composed of a wired or wireless control 23. The router (multiplexer) 24 receives a message—wired or wireless from the WAN on a wired DSL or wireless inputs from the screens in the kiosk ie. either voice, touch screen commands, ATM commands or PDA commands, etc or wireless receiving router, sends data to the CPU 26 analyzes the content shown in more detail in FIG. 9 and decides where to send the data just received: either wired if sending to the WAN or wireless if convenient—and in what format or protocol, it can be back to the WAN, which in turn can be wired or wireless—or to one of the wireless receiving/transmitting imbedded microprocessor display screens conveniently arranged in a kiosk or cluster format or to any of the devices with imbedded micro processing devices or to linked user devices ie. printer, ATM, PDA, MP3 player, etc. plugged in after having the imbedded microprocessor convert the data to the correct format or protocol. The CPU can send ie. raw video, from storage in the memory, live content from the WAN, content from advertisers, administrators or even from an authorized user who wants to upload his music, video, games software, or other data for distribution by the kiosk. The CPU router 24 after analyzing the data will decide if the content—ie. Raw video—will be sent to a wireless imbedded microprocessor receiving/transmitting touch screen FIG. 3 or to a wireless imbedded microprocessor in any of display advertising screen video display region 16 or to any of the interactive touch screens (17), and voice (eg. users speaking into the microphone 33 of FIG. 5a) information being entered on video voice channel 21 to the respective display screens 14, of the video display region 11 and the interactive display region 16. And would add as well as the interactive touchscreens monitors or any imbedded wired device in the kiosk or clusters (ie. printers, ATM, scanners, postal scale, or any other device capable of being used wirelessly) The main CPU computer 26 receives data content as well as control information via the data link 27, either wirelessly from inside the kiosk or clusters, wireless devices in the kiosk or clusters, or wired from the WAN or wirelessly from the WAN, or wireless devices held by any of the users accessing the kiosk, preferably from (the central control station) from a server either in the kiosk or outside in the WAN, or at any advertisers location, administrator, or user accessing the kiosk or cluster remotely controlling or interacting with the kiosks 20.

A digital voice link 24 wired or wirelessly connected to the server or imbedded microprocessor provides a voice communication link which may be switched over any of the speakers or voice outputs for the purpose of enabling two way interactive voice communication with any of the terminals (touch screens) 17 or display screens 14 if necessary. It follows that the digital voice link may transmit voice, music, or other audible content in any suitable format or protocol ie. digital D1/D3, ASCII etc. using modems or wireless transmission in any well known manner including wireless. The voice channel 21 may operate in D1/D3 digital carrier format or any other suitable digital network or protocol as may be most suitable depending on various factors such as location, prevailing tariffs and availability.

It should be noted that the invention concept as disclosed herein is not tied in to any data transmission format or protocol since data transmission is a constant evolving art, and that any suitable data transmission mode of transmitting, switching, and formatting may be contemplated in implementing the invention as long as the wireless transmission elements are included. The same considerations apply to operating system, platform architecture, and the data distribution architecture of the system, since numerous different arrangements may be contemplated for implementation of the invention.

FIG. 5a and FIG. 5b show in respective front and side views an interactive terminal. In the front view of FIG. 5a an interactive touch screen wired or wirelessly connected to the server or linked to the server by using sending/transmitting imbedded microprocessors in display screens is shown in front of a user at a convenient height and angle. The front panel may further include a video camera 32 (FIG. 5a) wired or wirelessly connected to the server or imbedded microprocessors in the display screens or the touch screens and a speaker/s 34 (FIG. 5a) wired or wirelessly connected to the server includes means for enabling the terminal to produce a printed document, such as receipt, ticket, photo, label or the like. Scanner bed 38 (FIG. 5a) wired or wirelessly connected to the server or linked to the server by wireless sending/transmitting imbedded microprocessors in the display screens or the touch screens enables a user to place a document on the scanner and transfer the document to hard copy through one of the printers, to store it in memory or in a CD by saving it to the CD burner, to send it as an e-mail, or to upload the scanned image to any personal memory device, wired device linked to any of the jacks or memory slots, or wirelessly to any destination including any wireless device, or screen in the kiosk or outside of the kiosk, ie. a PDA, cell phone, video capture device, camera, etc.

The front panel may further include a postal scale 3 (FIG. 5a) wired or wirelessly connected to the server or linked to wireless transmitting/receiving imbedded microprocessors in the display screens or the touch screens allowing a customer to drop a package and have the scale calculate the correct postage on different types of delivery and destinations, plus provide the printer with the information proceeding from voice recognition or touch screen or keyboard to print label with destination and remitting address a bar-coded information such as provided by the Postal service to facilitate handling by the postal machines (once it is picked up).

The front panel may further include a series jacks and memory slots or other interfaces (FIG. 5a) wired or wirelessly connected to the server or linked by wireless transmitting/receiving imbedded microprocessors in the display screens or the touch screens wired or wirelessly connected to the server or linked by imbedded microprocessors in the display screens or the touch screens. See FIG. 5a. The front panel may further include a biometric devices to identify users for secure transactions ie. through fingerprinting or iris identification.

The front panel may further include a signature pad to sign credit card charges or enter pin codes for ATM transactions (this can also if necessary be integrated in one of the interactive screens.) The touch screen may be of any type available in the market ie. overlay on a display device touch screen 14 (FIG. 5a with a wireless sender/receiver imbedded microprocessor or, or it may have its own imaging screen separate from the display device 14 as shown on (FIG. 5b).

FIG. 6 is a more detailed view of the touch screen 31 with a wireless sending/receiving imbedded microprocessor, where several display screens and or touch fields within a screen 39 serve to display information and prompts, and at the same time to in a well known manner.

FIG. 7 shows details of an interactive display region 16 having the above described matrix A-C and 1-5 rows and columns of display devices screens, a row of interactive screens 14 (can be as one of the possible spatial arrangements referenced previously in this filing as the more structured approach in the video wall format and other touch screens 31 with a wireless sending/receiving imbedded microprocessor screen linked wirelessly to the server CPU in the kiosk or LAN, WAN, to outside sources such as advertisers or to personal wireless device IR or RF Ie. Cell phones, PDA's etc.

As contemplated in FIG. 7 a (bank) 18 arrangement of wireless sending/receiving imbedded microprocessor screen linked wirelessly to the server CPU in the kiosk or LAN, WAN, to outside sources such as advertisers or to personal wireless device IR or RF serve to distribute data between the central server such as ie. the wireless transmitting computer (CPU) 26, wired or wirelessly linked to a WAN or outside advertiser, or user accessing the system through his wireless personal device ie. cell phone, smart card, or wired personal device ie memory card, or MP3 player, etc. and the individual display screens 14, or touch screens or the terminal touch screen 17. The processors preferably are mounted on the backside of the video wall 18 (see FIG. 4) connected to the computer 26 by cables or a wireless link from the wireless router sending/receiver interfaced with the CPU or kiosk, or LAN or WAN or wireless device of a user ie. IR/RF PDA, cell phones and the imbedded micro processor sender receiver in each display screen, the imbedded micro processor sender receiver touch screen, the imbedded micro processor sender receiver terminal or any other the imbedded micro processor sender receiver imbedded device desired to be linked wirelessly as a component of the kiosk 41 linked to wireless imbedded sender receivers in the back or base of the screens or any other device previously referenced.

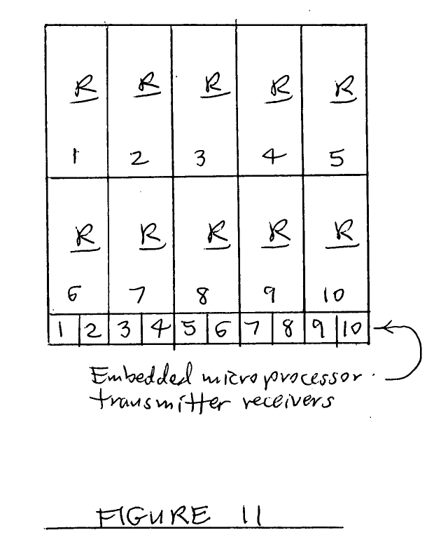

FIG. 8 shows an interactive display screen matrix 16 as in FIG. 7, with interactive display screens 16 arranged in rows A-D and columns 1-5 each screen having an imbedded microprocessor with a wireless transmitter receiver which links each screen directly to the wireless transmitter-server in the kiosk or to any other wireless link in a WAN or to any outside user with a wireless device authorized to link with the kiosk, or any of the display interactive screens, and a row of backup touch screens 14 (only if main touch screens 31 fail) with associated main touch screens 31 processors 18 as depicted in FIG. 7, it has processors with wireless transmitters receivers 18 as depicted in FIG. (8) each serving any of the display screens A-D or clustered screens or free standing screens via wireless transmitters 41—connected to the internet the WIRELESS hub also can optionally be wired to the server or wireless linked. The computer 42 acting as local server is adapted to exchange data or content with the rest of the world by any traditional method such as POTS modems 43, connected to the public switched telephone network, or an ISDN 44 and dedicated line adaptor are all connected via routing circuit 47 or wireless routing circuit 47 adaptor for connection with the integrated services digital network, and dedicated line adapters for interchange of data, voice, video, and digital information with dedicated data services as need may arise or via wireless links through the wireless transmitter receiving processor-server and any of the imbedded micro processing transmitters in the kiosk FIG. 8 region 16 or touch screens (see FIG. 8) region 31 or backup touch screens (see FIG. 8) region 14 or any other device with an imbedded wireless microprocessor i.e. printer, postal scale ATM, scanner, ticket printer, or interface. See FIG. 10.

### Method

In practicing the invention, the following method may be used. A method is provided of displaying information with a display system including a wireless sender; a wireless receiver; a central processing unit wireless controller; several microprocessors; several display screens 14 networked wirelessly to the central processing unit wireless controller, each the display device being linked to a corresponding the microprocessor with a wireless receiver and being linked to the wireless controller; and wireless data input means; where one of a wired/wireless receiver sends through a wireless server and wireless microcontroller receives an input signal from a wide area network from a user operating the wireless data input means and distributes signals to the wireless receiver and where the wireless controller signals directly to each of the display screens 14 and where the display screens 14 are arranged in a two dimensional matrix of the display screens 14 defining a video kiosk 20, the method including the step of: temporarily transferring an image from one display device to another display device for positioning an image at eye level in front of a user.

The method optionally includes the additional steps of: selecting a particular topic and touching a symbol identifying specific information about the particular topic; the system causing the symbols to vanish and displaying the specific information pertaining to the selected topic.

Touch screen elements may be linked in any convenient arrangement and operated by users in the kiosk by accessing the touch screens, voice inputs, or outside inputs such as IR, RF, smart cards, or memory cards in such a way that they can conveniently access content from any display or touch screen on the screen nearest them or on the screen of any such device a user may bring or may have as an interface to the kiosk ie: cell phones, credit cards, smart cards, PDA's, camera with USB link, etc.

Finally the cpu server controller transmitter/receiver can receive wired signals, i.e. POTS, ISDN, and so forth or wireless signals from a WAN or other LAN or wireless user and retransmit the content whatever it may be to an advertising screen wirelessly through the wireless cpu servers router to any imbedded screen or device, i.e. printer, ATM, ticket printer, biometric device already referenced herein including a single screen with multiple partitions on the screen as shown in the FIGURES.

It is contemplated that, either in place of or in addition to a multiscreen kiosk, that a single display screen 14 be partitioned into regions R for multiple advertisers, each region R being controlled by an imbedded microprocessor-transreceiver. See FIG. 11. This can be connected to a printer, an ATM, memory card slots S and so on, in separate free standing modules, each with a microprocessor. Each display screen 14 or group of screens 14 constitutes a local area network (LAN) (with each screen optionally partitioned into any number of advertisers each controlled by an imbedded microprocessor so that each screen becomes a LAN.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim as my invention:

1. A display system, comprising:
a receiver;
at least one microprocessor;
a plurality of display devices, each said display device being linked to said at least one microprocessor with said receiver;
and data input means;
wherein one of a server and a microcontroller receives an input signal from a wide area network from a user operating said data input means and distributes signals to said receiver and wherein said controller signals directly to each of said display devices.

2. The display system of claim 1, wherein each said display device comprises a peripheral which is one of a pay per view video, a gambling video, an interactive game video, and a printer; and peripheral signalling means.

3. The display device of claim 1, wherein said receiver is a wired receiver.

4. A display system, comprising:
a cpu server wireless controller router which is wired receiver from one of a wide area network, a wireless receiver from one of a wide area network and a PDA, a wireless sender, a central processing unit wireless controller, a WAN and authorized receiver in turn processing, routing and retransmitting content to one of a printer, an automatic teller machine, a ticket printer, a receiver, and a DVD-CD burner, and sending content to at least one imbedded microprocessor receiver;
a plurality of display devices each with imbedded microprocessor wireless transmitter receiver networked to said cpu server controller, each said display device being linked to said at least one microprocessor with said receiver;
and data input means;
wherein one of a cpu server microcontroller wireless router receives an input signal which is one of wired and wireless from a wide area network from a user operating said data input means and distributes signals to said receiver and wherein said controller signals directly to each of said display devices.

5. The display system of claim 2, wherein each said display device comprises a peripheral which is one of a pay per view video, a gambling video, an interactive game video, and a printer; and peripheral signalling means.

6. The display system of claim 2, wherein said display devices are networked to said cpu server controller wireless router wirelessly.

7. The display system of claim 2, wherein said display devices are networked to said cpu server controller wireless router through wires.

8. The display device of claim 2, wherein said data input means is connected to said cpu server controller wireless router wirelessly.

9. The display device of claim 2, wherein said data input means is connected to said cpu controller wireless router transmitter through a wire.

10. The display device of claim 2, wherein said receiver is a wireless receiver.

11. The display device of claim 2, wherein said receiver is a wired receiver.

12. The display system of claim 2, wherein said display devices are arranged in a two dimensional matrix of said display devices defining a video kiosk.

13. The display system of claim 2, wherein said signals are sent on one of: IP, ICP, OIP, IPX and proprietary protocols.

14. The display system of claim 2, wherein the signal received from said data input means is evaluated by said wireless server and said wireless server decides where the signal is routed.

15. The display system of claim 2, wherein said display devices are one of: monitors, CRT's, TFT's, liquid crystal displays and plasma screens.

16. The display system of claim 2, wherein said display devices are built into a supporting rack structure forming a video wall having a video wall forward facing side with the display devices extending forwardly from said video wall forward facing side.

17. The display system of claim 16, wherein said wireless data input means comprises one of: a touch screen, a voice input means, a pen pad, a PDA, a cellular telephone, and a wireless user interface.

18. The display system of claim 2, wherein said inputs comprise:
a smart memory device and;
one of: a radio frequency device and an infrared device.

19. The display system of claim 18, wherein said smart memory storage device is a smart card.

20. The display system of claim 19, wherein said smart card is one of an XMC, a MMC, and a jump drive.

21. The display system of claim 18, wherein said infrared device is one of: a remote control PDA, a handspring or a cell phone.

22. The display system of claim 1, wherein said cpu server controller is one or wired and wireless.

23. A method of displaying information with a display system, comprising a wireless sender; a wireless receiver; a central processing unit wireless controller; a plurality of microprocessors; a plurality of display devices networked wirelessly to said central processing unit wireless controller, each said display device being linked to a corresponding said microprocessor with a wireless receiver and being linked to said wireless controller; and wireless data input means; wherein one of a wireless server and wireless microcontroller receives an input signal from a wide area network from a user operating said wireless data input means and distributes signals to said wireless receiver and wherein said wireless controller signals directly to each of said display devices and wherein said display devices are arranged in a two dimensional matrix of said display devices defining a video kiosk, the method comprising the step of:
temporarily transferring an image from one display device to another display device for positioning an image at eye level in front of a user.

24. The method of claim 23, comprising the additional steps of:
selecting a particular topic and touching a symbol identifying specific information about the particular topic;
the system causing the symbols to vanish and displaying the specific information pertaining to the selected topic.

25. A display arrangement comprising at least a video display region and at least one interactive display region, the display region being arranged as a matrix having respective rows and columns of display devices, each display device being combined with a microprocessor, said interactive display region having a row of terminals, each terminal aligned with a respective display device, each terminal having a plurality of key elements each having a designated key function; and computing means in wireless operative engagement with said display devices, said display devices and said terminals operative for displaying information being stored in said computing means in response to manual inputs entered into said key elements.

26. The display arrangement of claim 25, wherein said key elements are touch screen elements.

27. The display arrangement of claim 25, wherein said video display region and said interactive display region are displayed in respective first and second planes.

28. A display arrangement comprising:
a video wall and a video display region and an interactive region which may be placed at will in any desired arrangement.
